(19) United States
(12) Patent Application Publication
(10) Pub. No.: US 2012/0041129 A1
(43) Pub. Date: Feb. 16, 2012

(54) RUBBER MIXTURES CONTAINING SILANE AND HAVING POSSIBLY FUNCTIONALIZED DIENE RUBBERS AND MICROGELS, A METHOD FOR THE PRODUCTION THEREOF, AND USE THEREOF

(75) Inventors: Norbert Steinhauser, Monheim (DE); Werner Obrecht, Moers (DE); David Hardy, Dormagen (DE); Thomas Gross, Wulfrath (DE)

(73) Assignee: LANXESS DEUTSCHLAND GMBH, Leverkusen (DE)

(21) Appl. No.: 13/144,777

(22) PCT Filed: Jan. 19, 2010
(86) PCT No.: PCT/EP2010/050571

§ 371 Date: Sep. 30, 2011

(30) Foreign Application Priority Data
Jan. 22, 2009 (DE) 102009005713.7

(51) Int. Cl. C08L 51/00; C08L 33/10; C08L 9/06; C08L 33/02; C08L 47/00; C08L 9/00

(52) U.S. Cl. 524/504; 525/105; 524/571; 524/575; 524/526; 524/556; 524/523

(57) ABSTRACT

The invention relates to rubber mixtures containing silane and having possibly functionalized diene rubbers and microgels, to a method for the production thereof, and to the use thereof to produce wet slipping resistant and low-rolling resistance motor vehicle tire treads having high abrasion resistance.

The present patent application claims the right of priority under 35 U.S.C. §119 (a)-(d) and 35 U.S.C. §365 of International Application No. PCT/EP2010/050571, filed 19 Jan. 2010, which was published in German as International Patent Publication No. WO2010/084114 on 29 Jul. 2010, which is entitled to the right of priority of German Patent Application No. 10 2009 005 713.7, filed 22 Jan. 2009.

The invention relates to silane-containing rubber mixtures with optionally functionalized diene rubbers and with microgels, their use for the production of wet-skid-resistant, low-rolling-resistance motor-vehicle tyre treads with high abrasion resistance, and a production process.

Important properties desired in tyre treads are good adhesion to dry and wet surfaces, and also high abrasion resistance. It is very difficult here to improve the skid resistance of a tyre without simultaneously impairing the rolling resistance and the abrasion resistance. Low rolling resistance is important for low fuel consumption, and high abrasion resistance is the decisive factor for long tyre lifetime.

Wet skid resistance and rolling resistance of a tyre tread depend largely on the dynamic mechanical properties of the rubber used to produce the mixture. In order to lower rolling resistance, rubbers with high rebound resilience at relatively high temperatures (from 60° C. to 100° C.) are used for the tyre tread. On the other hand, rubbers with a high damping factor at low temperatures (from 0 to 23° C.) or, respectively, low rebound resilience in the range from 0° C. to 23° C. are advantageous for improving wet skid resistance. In order to achieve this complex property profile, mixtures composed of various rubbers are used in tyre treads. The usual method uses mixtures composed of one or more rubbers with relatively high glass transition temperature, e.g. styrene-butadiene rubber, and one or more rubbers with relatively low glass transition temperature, for example polybutadiene with high 1,4-cis content or, respectively, a styrene-butadiene rubber with low styrene content and very low vinyl content or a polybutadiene produced in solution having moderate 1,4-cis content and low vinyl content.

Anionically polymerized solution rubbers containing double bonds, e.g. solution polybutadiene and solution styrene-butadiene rubbers, have advantages over corresponding emulsion rubbers for the production of low-rolling-resistance tyre treads. The advantages lie inter alia in the controllability of vinyl content and of the associated glass transition temperature and molecular branching. In practical applications this gives particular advantages in the relationship of wet skid resistance and rolling resistance of the tyre. By way of example, U.S. Pat. No. 5,227,425 describes the production of tyre treads from a solution SBR and silica. Numerous methods of end-group modification have been developed to provide a further improvement in properties, for example as described in EP-A 334 042 using dimethylaminopropylacrylamide, or as described in EP-A 447 066 using silyl ethers. However, because of the high molecular weight of the rubbers, the proportion by weight of the end groups is small, and these can therefore have only a small effect on the interaction between filler and rubber molecule. EP-A 1 000 971 discloses relatively highly functionalized carboxylated copolymers composed of vinylaromatics and of dienes, with up to 60% content of 1,2-bonded diene (vinyl content). US 2005/0 256 284 A 1 describes copolymers composed of diene and of functionalized vinylaromatic monomers. The disadvantage of the said copolymers lies in the complicated synthesis of the functionalized vinylaromatic monomers and in the severe restriction in the selection of the functional groups, since the only functional groups that can be used are those which do not enter into any reaction with the initiator during the anionic polymerization process. In particular, functional groups that have hydrogen atoms which are capable of forming hydrogen bonds and which are therefore capable of interacting particularly advantageously with the filler within the rubber mixture cannot be incorporated into the polymer either by anionic polymerization or by Ziegler/Natta polymerization.

The literature discloses a wide variety of measures for reducing the rolling resistance of tyres, one of these being the use of polychloroprene gels (EP-A 405 216) and polybutadiene gels (DE-A 42 20 563) in tyre treads composed of rubbers containing C═C double bonds. There are disadvantages in the use of polychloroprene gel deriving from the high rubber price, the high density of polychloroprene, and the environmental disadvantages expected from the chlorine-containing component during the process of recycling of used tyres. Although polybutadiene gels according to DE-A 42 20 563 do not exhibit the said disadvantages, dynamic damping is lowered here not only at low temperatures (from −20 to +20° C.) but also at relatively high temperatures (40-80° C.), and in practice although this leads to advantages in rolling resistance it leads to disadvantages in wet skid performance of the tyres. Sulphur-crosslinked rubber gels according to GB Patent 1 078 400 do not exhibit any reinforcing effect and are therefore unsuitable for the present application.

In contrast, the microgel-containing functionalized rubber mixtures (containing styrene/butadiene rubber gel) described in DE 102008052116.7 intrinsically have a better property profile, but this still requires further optimization.

It was therefore an object to provide rubber mixtures which do not have the disadvantages of the prior art, and which have an improved property profile.

Surprisingly, it has now been found that the rubber mixtures of the invention, comprising (A) at least one optionally functionalized diene rubber having a polymer chain composed of repeat units based on at least one diene and optionally on one or more vinylaromatic monomers and (B) optionally a styrene/butadiene rubber gel with a swelling index in toluene of from 1 to 25 and with a particle size of from 5 to 1000 nm, and also (C) at least one specific silane, and (D) optionally further rubbers, fillers and rubber auxiliaries have high dynamic damping at low temperature and low dynamic damping at relatively high temperature, therefore giving advantages not only in rolling resistance but also in wet skid performance, and also in relation to abrasion.

The invention therefore provides rubber mixtures, comprising (A) at least one optionally functionalized diene rubber having a polymer chain composed of repeat units based on at least one diene and optionally on one or more vinylaromatic monomers and (B) optionally a styrene/butadiene rubber gel with a swelling index in toluene of from 1 to 25 and with a particle size of from 5 to 1000 nm, and also (C) a silane of the formula (I)

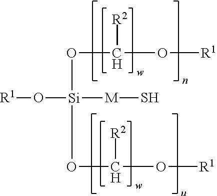

where R¹=hydrogen or a hydrocarbon moiety having from 1 to 20 carbon atoms, which can be linear, branched, aliphatic, cycloaliphatic or aromatic and which can optionally contain further heteroatoms, e.g. oxygen, nitrogen and/or sulphur,
R²=hydrogen or methyl,
and M is a spacer which can contain a hydrocarbon moiety having from 1 to 20 carbon atoms and can be linear, branched, aliphatic, cycloaliphatic or aromatic and which can optionally contain further heteroatoms, e.g. oxygen, nitrogen and/or sulphur, and
n=from 0 to 25,
u=from 0 to 25,
w=from 1 to 40, preferably from 2 to 20, very particularly preferably 2,
and R¹, R² and/or w can, within the silane, be identical or different,
and (D) optionally further rubbers, fillers and rubber auxiliaries.

Dienes in the optionally functionalized diene rubber (A) are preferably 1,3-butadiene, isoprene, 1,3-pentadiene, 2,3-dimethylbutadiene, 1-phenyl-1,3-butadiene and/or 1,3-hexadiene. It is particularly preferable to use 1,3-butadiene and/or isoprene.

Preferred vinylaromatic monomers for the purposes of the invention are styrene, o-, m- and/or p-methylstyrene, p-tert-butylstyrene, α-methylstyrene, vinylnaphthalene, divinylbenzene, trivinylbenzene and/or divinylnaphthalene. It is particularly preferable to use styrene.

In one preferred embodiment of the invention, the optionally functionalized diene rubbers (A) have from 0 to 60% by weight, preferably from 15 to 45% by weight, content of copolymerized vinylaromatic monomers and from 40 to 100% by weight, preferably from 55 to 85% by weight, content of dienes, where the content of 1,2-bonded dienes (vinyl content) is from 0.5 to 95% by weight, preferably from 10 to 85% by weight, and the entirety composed of copolymerized vinylaromatic monomers and dienes gives a total of 100%.

The functionalized diene rubbers (A) are particularly preferably composed of from 40 to 100% by weight of 1,3-butadiene and from 0 to 60% by weight of styrene, where the proportion of bonded functional groups and/or of their salts is from 0.02 to 5% by weight, based on 100% by weight of diene rubber.

Examples of functional groups and/or their salts within the functionalized diene rubber are carboxy, hydroxy, amine, carboxylic ester, carboxamide or sulphonic acid groups. Preference is given to carboxy or hydroxy groups. Preferred salts are alkali metal carboxylates, alkaline earth metal carboxylates, zinc carboxylates and ammonium carboxylates, and also alkali metal sulphonates, alkaline earth metal sulphonates, zinc sulphonates and ammonium sulphonates.

In one very particularly preferred embodiment of the invention, (A) is a functionalized diene rubber which is composed of repeat units based on 1,3-butadiene and styrene, and which has been functionalized by hydroxy groups and/or by carboxy groups.

The diene rubbers (A) here are preferably produced via polymerization of dienes and optionally of vinylaromatic monomers in solution by the processes known from the prior art. The functionalized diene rubbers (A) are produced from the non-functionalized rubbers described above via subsequent introduction of functional groups, as described by way of example in DE 102008023885.6.

Styrene/butadiene rubber gels (B) are microgels produced via crosslinking of
SBR—styrene/butadiene copolymers having styrene contents of from 0 to 100% by weight, preferably from 10 to 60% by weight, and/or
XSBR—styrene/butadiene copolymers and graft polymers with further polar unsaturated monomers, such as acrylic acid, methacrylic acid, acrylamide, methacrylamide, N-methoxymethylmethacrylamide, N-acetoxymethylmethacrylamide, acrylonitrile, dimethylacrylamide, hydroxyethyl acrylate, hydroxypropyl acrylate, hydroxybutyl acrylate, hydroxyethyl methacrylate, hydroxypropyl methacrylate, hydroxybutyl methacrylate, ethylene glycol dimethacrylate, butanediol dimethacrylate, trimethylolpropane trimethacrylate, pentaerythritol tetramethacrylate, having styrene contents of from 0 to 99% by weight and contents of from 1 to 25% by weight of copolymerized polar monomers.

For the styrene/butadiene rubber gels (B), particular preference is given to XSBR-styrene/butadiene copolymers and graft polymers containing hydroxyethyl methacrylate, hydroxypropyl methacrylate, hydroxybutyl methacrylate, ethylene glycol dimethacrylate, trimethylolpropane trimethacrylate and/or pentaerythritol tetramethacrylate as polar unsaturated monomers.

The scope of the term copolymers includes polymers composed of 2 or more monomers.

By way of example here, the scope also includes those microgels that are obtained via copolymerization of the following monomers: butadiene, styrene, trimethylolpropane trimethacrylate and hydroxyethyl methacrylate, in emulsion.

The scope also covers the microgels described in EP-A 1935926.

The particle size of the styrene/butadiene rubber gels is from 5 to 1000 nm, preferably from 20 to 400 nm (DVN value to DIN 53 206) and their swelling indices (Qᵢ) in toluene are from 1 to 25, preferably from 1 to 20. The swelling index is calculated from the weight of the solvent-containing gel (after centrifuging at 20 000 rpm) and the weight of the dry gel:

Qᵢ wet weight of gel/dry weight of gel.

To determine the swelling index, by way of example, 250 mg of SBR gel is swollen with shaking for 24 hours in 25 ml of toluene. The gel is removed by centrifuging and weighed, and then dried at 70° C. to constant weight and again weighed.

In one preferred embodiment, the styrene/butadiene rubber gels (B) are XSBR-styrene/butadiene copolymers with hydroxy group content of from 20 to 50 mg KOH/g. The hydroxy group content of the styrene/butadiene rubber gels (B) here is determined to DIN 53240 in the form of hydroxy number with the dimension mg KOH/g of polymer, via reaction with acetic anhydride and titration of the resultant liberated acetic acid with KOH.

The production of the styrene/butadiene rubber starting products is known to the person skilled in the art and is preferably achieved via emulsion polymerization. In this context, reference is made by way of example to I. Franta, Elastomers and Rubber Compounding Materials, Elesevier, Amsterdam 1989, pages 88 to 92.

The crosslinking of the rubber starting products to give styrene/butadiene rubber gels (B) takes place in the latex state and can firstly be achieved during the polymerization process via copolymerization with polyfunctional monomers, and continuation of the polymerization process to high conversions, or, in the monomer feed process, via polymerization using high internal conversions, or can be carried out subsequently to the polymerization process via post-crosslinking, or else can be carried out via a combination of the two processes. Another possibility is production via polymerization in the presence of regulators, e.g. thiols.

In crosslinking of the styrene/butadiene rubber via copolymerization with crosslinking polyfunctional compounds, it is preferable to use polyfunctional comonomers having at least two, preferably from 2 to 4, copolymerizable C═C double bonds, e.g. diisopropenylbenzene, divinylbenzene, divinyl ether, divinyl sulphone, diallyl phthalate, triallyl cyanurate, triallyl isocyanurate, 1,2-polybutadiene, N,N′-m-phenylene maleimide and/or triallyl trimellitate. Examples of other compounds that can be used are: the acrylates and methacrylates of polyhydric, preferably di- to tetrahydric, C₂-C₁₀ alcohols, such as ethylene glycol, 1,2-propanediol, butanediol, hexanediol, polyethylene glycol having from 2 to 20, preferably from 2 to 8, oxyethylene units, neopentyl glycol, bisphenol A, glycerol, trimethylolpropane, pentaerythritol, sorbitol and unsaturated polyesters composed of aliphatic di- and polyols, and also maleic acid, fumaric acid and/or itaconic acid. The amounts preferably used of the polyfunctional compounds are from 0.5 to 15% by weight, particularly from 1 to 10% by weight, based on the entire monomer mixture.

The crosslinking of the styrene/butadiene rubbers to give SBR rubber gels can also be achieved in latex form via post-crosslinking by crosslinking chemicals. Examples of suitable crosslinking chemicals are organic peroxides, e.g. dicumyl peroxide, tert-butyl cumyl peroxide, bis(tert-butylperoxyisopropyl)benzene, di-tert-butyl peroxide, dibenzoyl peroxide, bis(2,4-dichlorobenzoyl) peroxide, tert-butyl perbenzoate or else organic azo compounds, such as azobisisobutyronitrile and azobiscyclohexanonitrile, or else di- and polymercapto compounds, such as dimercaptoethane, 1,6-dimercaptohexane, 1,3,5-trimercaptotriazine, or mercapto-terminated polysulphide rubbers, such as mercapto-terminated reaction products of bischloroethyl formal with sodium polysulphide. The ideal temperature for carrying out the post-crosslinking process is naturally dependent on the reactivity of the crosslinking agent and it can be carried out at temperatures of from room temperature to about 170° C., optionally at elevated pressure. In this connection, see Houben-Weyl, Methoden der organischen Chemie [Methods of organic chemistry], 4th Edition, Vol. 14/2, page 848. Peroxides are particularly preferred crosslinking agents. In this connection, reference is made by way of example to EP-A 1 307 504.

It is also optionally possible to enlarge the particles via agglomeration prior to, during or after the post-crosslinking process in latex form.

Styrene/butadiene rubbers produced in organic solvents can also serve as starting products for the production of the styrene/butadiene rubber gels. In this case it is advisable to emulsify the solution of the rubber, optionally with the aid of an emulsifier, in water, and to crosslink the resultant emulsion subsequently, prior to or after removal of the organic solvent, using suitable crosslinking agents. The abovementioned crosslinking agents are suitable crosslinking agents.

In one preferred embodiment of the invention, the proportion of the styrene/butadiene rubber gel (B), based on 100 parts by weight of the total amount of rubber, is from 1 to 100 parts by weight, particularly preferably from 5 to 75 parts by weight. The scope of the term entire amount includes both the functionalized diene rubber and also the optionally present abovementioned rubbers.

Compounds having the following general formula (I) are suitable as silane (C)

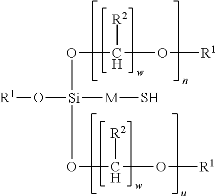

where R¹=hydrogen or a hydrocarbon moiety having from 1 to 20 carbon atoms, which can be linear, branched, aliphatic, cycloaliphatic or aromatic and which can optionally contain further heteroatoms, e.g. oxygen, nitrogen and/or sulphur,
preferably, R¹=C₁-C₁₅ alkyl,
R²=hydrogen or methyl,
and M is a spacer which can contain a hydrocarbon moiety having from 1 to 20 carbon atoms and can be linear, branched, aliphatic, cycloaliphatic or aromatic and which can optionally contain further heteroatoms, e.g. oxygen, nitrogen and/or sulphur, and
n=from 0 to 25, preferably from 3 to 10,
u=from 0 to 25,
w=from 1 to 40, preferably from 2 to 20, very particularly preferably 2,
and R¹, R² and/or w can, within the molecule, be identical or different.

The compound of the formula (II) is particularly preferably used as silane (C).

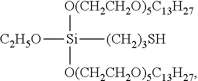

individually or optionally in a mixture with the abovementioned or other commercially available silanes.

When the silane of the formula (II) is used, preference is given to combination with a functionalized diene rubber (A) in the presence of a rubber gel (B) in the presence of component (D).

The total amounts advantageously used of the silane (C) are from 0.2 phr to 15 phr, based on 100 parts by weight of all rubbers. In cases where the silane of the formula (I) is used with other commercially available silanes, the amount of the silane of the formula (I) in the silane mixture is preferably at least 50%.

Silanes of the formula (I) can be produced by processes known from the prior art, for example as described in WO2007/068555 or EP-A-1285926.

The silane of the formula (II) is a commercially available product, obtainable by way of example from Evonik Industries AG/Evonik Degussa GmbH (see also http://www.degussa-fp.de/fp/de/gesch/gummisilane/default.htm?Product=366).

Particular preference is given here to the following combinations composed of
a) at least one unfunctionalized styrene-butadiene rubber with at least one microgel and with at least one silane of the formula (II) (see Example 2* of the invention),
b) at least one functionalized styrene-butadiene rubber with at least one silane of the formula (II) (see Example 3* of the invention) or
c) at least one functionalized styrene-butadiene rubber with at least one microgel and with at least one silane of the formula (II) (see Example 4* of the invention).

The rubber mixtures of the invention can also comprise, as component (D), alongside the optionally functionalized diene rubbers (A) mentioned and alongside the styrene/butadiene rubber gel (B) other rubbers, such as natural rubber, or else other synthetic rubbers. The amount of this component, if it is present, is usually in the range from 0.5 to 85 phr, preferably from 10 to 75 phr, based on the total amount of rubber in the rubber mixture. The amount of additionally added rubbers in turn depends on the respective intended use of the rubber mixtures of the invention.

Examples of additional rubbers are natural rubber, and also synthetic rubber.

Synthetic rubbers known from the literature are listed here by way of example. The scope of these includes inter alia
BR—Polybutadiene
ABR—Butadiene-C₁-C₄-alkyl acrylate copolymers
IR—Polyisoprene
ESBR—Styrene-butadiene copolymers having styrene contents of from 1 to 60% by weight, preferably from 20 to 50% by weight, produced via emulsion polymerization
IIR—Isobutylene-isoprene copolymers
NBR—Butadiene-acrylonitrile copolymers having acrylonitrile contents of from 5 to 60% by weight, preferably from 10 to 40% by weight
HNBR—partially hydrogenated or fully hydrogenated NBR rubber
EPDM—ethylene-propylene-diene terpolymers
   and also mixtures of these rubbers. Materials of interest for the production of motor vehicle tyres are in particular natural rubber, ESBR, and also solution SBR, polybutadiene rubber with high cis-content (>90%), produced using catalysts based on Ni, Co, Ti or Nd and also polybutadiene rubber having vinyl content of up to 80%, and also mixtures of these.

Fillers that can be used for the rubber mixtures according to the invention comprise all the known fillers used in the rubber industry. The scope of these encompasses not only active fillers but also inert fillers.

Examples that may be mentioned are:
fine-particle silicas, produced by way of example via precipitation from silicates with acids, or flame hydrolysis of silicon halides with specific surface areas of from 5 to 1000 m²/g (BET surface area), preferably from 20 to 400 m²/g, and with primary particle sizes of from 10 to 400 nm. The silicas can, if appropriate, also take the form of mixed oxides with other metal oxides, such as oxides of Al, of Mg, of Ca, of Ba, of Zn, of Zr, or of Ti;
synthetic silicates, such as aluminium silicate, or alkaline earth metal silicate, e.g. magnesium silicate or calcium silicate, with BET surface areas of from 20 to 400 m²/g and with primary particle diameters of from 10 to 400 nm;
natural silicates, such as kaolin and any other naturally occurring form of silica;
glass fibres and glass-fibre products (mats, strands), or glass microbeads;
metal oxides, such as zinc oxide, calcium oxide, magnesium oxide, or aluminium oxide;
metal carbonates, such as magnesium carbonate, calcium carbonate, or zinc carbonate;
metal hydroxides, e.g. aluminium hydroxide or magnesium hydroxide;
metal sulphates, such as calcium sulphate or barium sulphate;
carbon blacks: The carbon blacks for use here are those prepared by the flame process, channel process, furnace process, gas process, thermal process, acetylene process or arc process, their BET surface areas being from 9 to 200 m²/g, e.g. SAF, ISAF-LS, ISAF-HM, ISAF-LM, ISAF-HS, CF, SCF, HAF-LS, HAF, HAF-HS, FF-HS, SPF, XCF, FEF-LS, FEF, FEF-HS, GPF-HS, GPF, APF, SRF-LS, SRF-LM, SRF-HS, SRF-HM- and MT carbon blacks, or the following types according to ASTM classification: N 110, N219, N220, N231, N234, N242, N294, N326, N327, N330, N332, N339, N347, N351, N356, N358, N375, N472, N539, N550, N568, N650, N660, N754, N762, N765, N774, N787 and N990 carbon blacks;
rubber gels, in particular those based on polybutadiene and/or polychloroprene with particle sizes from 5 to 1000 nm.

Preferred fillers used are fine-particle silicas and/or carbon blacks.

The fillers mentioned can be used alone or in a mixture. In one particularly preferred embodiment, the rubber mixtures comprise, as fillers, a mixture composed of pale-coloured fillers, such as fine-particle silicas, and of carbon blacks, where the mixing ratio of pale-coloured fillers to carbon blacks is from 0.01:1 to 50:1, preferably from 0.05:1 to 20:1.

The amounts used of the fillers here are in the range from 10 to 500 parts by weight, based on 100 parts by weight of rubber. It is preferable to use from 20 to 200 parts by weight.

In another embodiment of the invention, the rubber mixtures also comprise rubber auxiliaries, which by way of example improve the processing properties of the rubber mixtures, or serve for the crosslinking of the rubber mixtures, or improve the physical properties of the vulcanizates produced from the rubber mixtures of the invention, for the specific intended purpose of the said vulcanizates, or improve the interaction between rubber and filler, or serve for the coupling of the rubber to the filler.

Examples of rubber auxiliaries are crosslinking agents, e.g. sulphur or sulphur-donor compounds, and also reaction accelerators, antioxidants, heat stabilizers, light stabilizers, antiozone agents, processing aids, plasticizers, tackifiers, blowing agents, dyes, pigments, waxes, extenders, organic acids, silanes, retarders, metal oxides, extender oils, e.g. DAE (distillate aromatic extract) oil, TDAE (treated distillate aromatic extract) oil, MES (mild extraction solvates) oil, RAE (residual aromatic extract) oil, TRAE (treated residual aromatic extract) oil, and naphthenic and heavy naphthenic oils, and also activators.

The total amount of rubber auxiliaries is in the range from 1 to 300 parts by weight, based on 100 parts by weight of entirety of rubber. It is preferable to use from 5 to 150 parts by weight of rubber auxiliaries.

The invention also provides a process for the production of the rubber mixtures of the invention, according to which at least one optionally functionalized diene rubber is mixed optionally with at least one styrene-butadiene rubber gel, with a silane of the formula (I) and optionally with further rubbers, fillers and rubber auxiliaries, in the abovementioned amounts, at temperatures of from 20 to 220° C. in a mixing apparatus.

The production of the mixture can be achieved in a single-stage process or in a multistage process, preference being given to from 2 to 3 mixing stages. It is preferable to add sulphur and accelerator in the final mixing stage, e.g. on a roll mill, the temperatures preferred here being from 30 to 90° C.

Examples of suitable assemblies for producing the mixture are roll mills, kneaders, internal mixers or mixing extruders.

The invention further provides the use of the rubber mixtures of the invention for the production of rubber vulcanizates, especially for the production of tyres, in particular tyre treads.

The rubber mixtures of the invention are also suitable for the production of mouldings, e.g. for the production of cable sheathing, of hoses, of drive belts, of conveyor belts, of roll coverings, of shoe soles, of gasket rings and of damping elements.

Examples below serve to illustrate the invention, but without any limiting effect.

### EXAMPLES

### Production of a Styrene/Butadiene Rubber Gel

For the compounding study, a styrene/butadiene rubber gel with Tg=−15° C. was used. The insoluble fraction of the said gel in toluene is 95% by weight. The swelling index in toluene is 7.4. The hydroxyl number is 32.8 mg KOH/g of gel.

The gel was produced via 7 hours of copolymerization of the following monomer mixture at 30° C. in the presence of 300 parts (based on the stated parts of monomer) of water, 4.5 parts of resin acid, 0.1 part of paramenthyl hydroperoxide, 0.07 part of sodium ethylenediamine tetraacetate, 0.05 part of iron sulphate heptahydrate and 0.15 part of sodium formaldehyde-sulphoxylate as initiator.

| | Quantitative |
|---|---|
| | proportions |
| Monomers | [parts by weight] |
| Butadiene | 44.5 |
| Styrene | 46.5 |
| Trimethylolpropane trimethacrylate | 1.5 |
| Hydroxyethyl methacrylate | 7.5 |

The mixture was then heated and the residual monomers were removed via steam distillation at reduced pressure and at a temperature of 70° C. Then 2 parts (based on 100 parts of product) of the antioxidant 2,2-methylenebis(4-methyl-6-tert-butylphenol) (CAS No.: 119-47-1), based on 100 parts of product, were added.

The latex was then added to an aqueous solution of sodium chloride/sulphuric acid, in order to bring about coagulation. The rubber crumbs were isolated and washed with water, and dried under reduced pressure at 50° C.

For the rubber mixture, a styrene-butadiene rubber (SBR) with the following constitution was used as functionalized diene rubber:

vinyl content: 46% by weight, based on oil-free rubber,
styrene content: 24.5% by weight, based on oil-free rubber,
Mooney viscosity: 52 MU, determined as ML1+4 (100° C.) to DIN 53 523,
oil content (TDAE oil): 29.1% by weight, based on oil-extended rubber,
COOH functionality: 35 meq/kg.

For comparison, the non-functionalized styrene-butadiene rubber BUNA VSL 5025-2, a product from Lanxess Deutschland GmbH (Lanxess) was used, with the following constitution:

vinyl content: 46% by weight, based on oil-free rubber,
styrene content: 24% by weight, based on oil-free rubber,
Mooney viscosity: 50 MU, determined as ML1+4 (100° C.) to DIN 53 523,
oil content (TDAE oil): 27.5% by weight, based on oil-extended rubber,

Table 1 below collates the constitutions of the rubber mixtures:

TABLE 1
Constitution of unvulcanized rubber mixtures (where the “*” characterizing
Examples 2*, 3* and 4* indicates that these are of the invention)

| | | Ex. 2* | Ex. 3* | Ex. 4* |
|---|---|---|---|---|
| | Ex. 1 | of the | of the | of the |
| Starting materials in phr | comparison | invention | invention | invention |
| BUNA VSL 5025-2 (non- | 96.3 | 96.3 | 0 | 0 |
| functionalized) | | | | |
| SBR (functionalized) | 0 | 0 | 97.6 | 97.6 |
| high-cis polybutadiene (BUNA CB 24, | 30 | 30 | 30 | 30 |
| Lanxess Deutschland GmbH) | | | | |
| Styrene-butadiene rubber gel | 0 | 15 | 0 | 15 |
| Silica (ULTRASIL 7000 GR, Evonik) | 90 | 90 | 90 | 90 |
| Carbon black (VULCAN J/N375, | 7 | 7 | 7 | 7 |
| Cabot) | | | | |
| TDAE oil (VIVATEC 500, Hansen und | 10 | 10 | 8.7 | 8.7 |
| Rosenthal) | | | | |
| Zinc soap (AKTIPLAST GT, | 3.5 | 3.5 | 3.5 | 3.5 |
| RheinChemie Rheinau GmbH) | | | | |
| Stearic acid (EDENOR C 18 98-100, | 1 | 1 | 1 | 1 |
| Cognis Deutschland GmbH) | | | | |
| Antioxidant (VULKANOX ® | 2 | 2 | 2 | 2 |
| 4020/LG, Lanxess) | | | | |
| Antioxidant (VULKANOX ® HS/LG, | 2 | 2 | 2 | 2 |
| Lanxess) | | | | |
| Zinc oxide (ZINKWEISS | 2 | 2 | 2 | 2 |
| ROTSIEGEL, Grillo Zinkoxid GmbH) | | | | |
| Silane according to formula (II) (VP SI | 10.1 | 10.1 | 10.1 | 10.1 |
| 363, Evonik) | | | | |
| Light-stabilizer wax (ANTILUX ® 654, | 2 | 2 | 2 | 2 |
| RheinChemie Rheinau GmbH) | | | | |
| Sulphonamide (VULKALENT E/C, | 0.2 | 0.2 | 0.2 | 0.2 |
| Lanxess) | | | | |
| Sulphur (MAHLSCHWEFEL 90/95 | 2.2 | 2.2 | 2.2 | 2.2 |
| CHANCEL ®, Solvay Barium | | | | |
| Strontium) | | | | |
| Benzothiazolesulphenamide | 1.6 | 1.6 | 1.6 | 1.6 |
| (VULKACIT NZ/EGC, Lanxess) | | | | |
| Thiuram (RHENOGRAN TBZTD-70, | 0.29 | 0.29 | 0.29 | 0.29 |
| RheinChemie Rheinau GmbH) | | | | |

The abovementioned mixtures (without sulphur, benzothiazolesulphenamide, thiuram, and also sulphonamide) were mixed for a total of 6 minutes in a first mixing stage in a 1.5 L kneader, whereupon the temperature rose within a period of 3 minutes from 70 to 150° C. and the mixture was kept at 150° C. for 3 minutes. The entire amount of the silane was also added in the 1st mixing stage.

The mixtures were then discharged and cooled for 24 hours to room temperature and, in a 2nd mixing stage, again heated to 150° C. for 3 minutes. They were then cooled, and the following constituents of the mixture were added on a roll mill at from 40 to 60° C.: sulphur, benzothiazolesulphenamide, thiuram, and also sulphonamide.

The values collated in Table 2 were determined on the unvulcanized rubber mixtures.

TABLE 2
Properties of the unvulcanized rubber mixtures produced
in Table 1 (where the “*” characterizing Examples
2*, 3* and 4* indicates that these are of the invention)

| | Ex. 1 | Ex. 2* | Ex. 3* | Ex. 4* |
|---|---|---|---|---|
| ML 1 + 1 (100° C.) [MU] | 61.3 | 67.5 | 69.3 | 80.0 |
| ML 1 + 4 (100° C.) [MU] | 55.6 | 61.2 | 63.2 | 73.1 |
| Mooney relaxation/10 sec. [%] | 21.0 | 22.0 | 22.7 | 25.3 |
| Mooney relaxation/30 sec. [%] | 14.6 | 15.5 | 16.3 | 18.8 |

The vulcanization behaviour of the mixtures was studied in a rheometer at 160° C. to DIN 53 529 with the aid of a Monsanto MDR 2000E rheometer. Characteristic data, such as Fₐ, Fₘₐₓ, F_{max.}−Fₐ, t₁₀, t₅₀, t₉₀ and t₉₅ were thus determined.

The definitions according to DIN 53 529, Part 3, are:

Fₐ: vulcameter value indicated at minimum of crosslinking isotherm
Fₘₐₓ: maximum vulcameter value indicated
Fₘₐₓ−Fₐ: difference between maximum and minimum of vulcameter values indicated
t₁₀: juncture at which 10% of final conversion has been achieved
t₅₀: juncture at which 50% of final conversion has been achieved
t₉₀: juncture at which 90% of final conversion has been achieved
t₉₅: juncture at which 95% of final conversion has been achieved

TABLE 3
Vulcanization behaviour of the rubber mixtures produced
in Table 1 (where the “*” characterizing Examples
2*, 3* and 4* indicates that these are of the invention)

| | Ex. 1 | Ex. 2* | Ex. 3* | Ex. 4* |
|---|---|---|---|---|
| Fₐ [dNm] | 2.14 | 2.62 | 1.93 | 2.70 |
| Fₘₐₓ [dNm] | 17.77 | 15.76 | 13.50 | 14.41 |
| Fₘₐₓ − Fₐ [dNm] | 15.63 | 13.14 | 11.57 | 11.71 |
| t₁₀ [sec] | 240.8 | 259.0 | 295.0 | 274.3 |
| t₅₀ [sec] | 404.2 | 458.7 | 476.6 | 469.5 |
| t₉₀ [sec] | 721.0 | 800.8 | 855.2 | 814.7 |
| t₉₅ [sec] | 904.7 | 1005 | 1066 | 994.3 |
| t₉₀ − t₁₀ [sec] | 480.2 | 541.8 | 560.2 | 540.4 |

The abovementioned mixtures were vulcanized in the press at 160° C. for 20 minutes. The values collated in Table 4 were determined on the vulcanizates.

TABLE 4
Vulcanizate properties of the rubber mixtures produced
in Table 1 (where the “*” characterizing Examples
2*, 3* and 4* indicates that these are of the invention)

| | Ex. 1 | Ex. 2* | Ex. 3* | Ex. 4* |
|---|---|---|---|---|
| Shore A hardness at 23° C. (DIN | 59.1 | 59.7 | 58.7 | 61.6 |
| Shore A hardness at 70° C. (DIN | 57.9 | 57.3 | 56.5 | 59.0 |
| Rebound resilience at 23° C. [%] | 40.5 | 33.0 | 40.0 | 34.5 |
| (DIN 53512) | | | | |
| Rebound resilience at 60° C. [%] | 62.5 | 63.0 | 65.0 | 64.5 |
| (DIN 53512) | | | | |
| σ₁₀ (DIN 53504) [MPa] | 0.4 | 0.4 | 0.4 | 0.4 |
| σ₂₅ (DIN 53504) [MPa] | 0.7 | 0.8 | 0.7 | 0.7 |
| σ₅₀ (DIN 53504) [MPa] | 1.1 | 1.2 | 1.1 | 1.2 |
| σ₁₀₀ (DIN 53504) [MPa] | 1.9 | 2.2 | 2.2 | 2.4 |
| σ₃₀₀ (DIN 53504) [MPa] | 10.0 | 11.0 | 13.1 | 14.7 |
| σ₃₀₀/σ₂₅ | 14.3 | 13.8 | 18.7 | 21.0 |
| Tensile strength (DIN 53504) | 19.2 | 19.7 | 20.6 | 18.0 |
| [MPa] | | | | |
| Elongation at break (DIN 53504) | 486 | 480 | 419 | 348 |
| [%] | | | | |
| Abrasion (DIN 53516) [mm³] | 86 | 84 | 77 | 70 |
| E′ (0° C.)/10 Hz [MPa] | 20.2 | 25.3 | 14.6 | 23.3 |
| E″(0° C.)/10 Hz [MPa] | 6.8 | 13.3 | 7.0 | 13.5 |
| E′ (60° C.)/10 Hz [MPa] | 7.6 | 5.1 | 4.9 | 4.8 |
| E″(60° C.)/10 Hz [MPa] | 0.7 | 0.5 | 0.5 | 0.4 |
| tan δ at 0° C. | 0.337 | 0.528 | 0.478 | 0.577 |
| (dynamic damping at 10 Hz) | | | | |
| tan δ at 60° C. | 0.096 | 0.088 | 0.093 | 0.088 |
| (dynamic damping at 10 | | | | |
| ΔG* (G* (0.5% elongation)-G* | 0.90 | 0.53 | 0.49 | 0.42 |
| (15% elongation)) [MPa] | | | | |
| (MTS at 1 | | | | |

Tyre applications require low rolling resistance, and this is obtained when a high value for rebound resilience at 60° C., a low tan δ value for dynamic damping at high temperature (60° C.), and also a low ΔG* are measured in the vulcanizate. As can be seen from Table 4, the vulcanizates of the examples of the invention feature high rebound resilience values at 60° C., low tan δ values for dynamic damping at 60° C., and also low ΔG* values.

Tyre applications also require high wet skid resistance, and this is obtained when the vulcanizate has a high tan δ value for dynamic damping at low temperature (0° C.). As can be seen from Table 4, the vulcanizates of the examples of the invention feature high tan δ values for dynamic damping at 0° C.

Tyre applications moreover require high abrasion resistance. As can be seen from Table 4, the vulcanizates of the examples of the invention feature reduced DIN abrasion values.

What is claimed is:

1. Rubber mixtures, comprising (A) at least one optionally functionalized diene rubber having a polymer chain composed of repeat units based on at least one diene and optionally on one or more vinylaromatic monomers and (B) optionally a styrene/butadiene rubber gel with a swelling index in toluene of from 1 to 25 and with a particle size of from 5 to 1000 nm, and also (C) a silane of the formula (I) 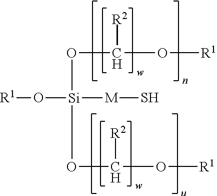
where R¹=hydrogen or a hydrocarbon moiety having from 1 to 20 carbon atoms, which can be linear, branched, aliphatic, cycloaliphatic or aromatic and which can optionally contain further heteroatoms,
R²=hydrogen or methyl,
and M is a spacer which can contain a hydrocarbon moiety having from 1 to 20 carbon atoms and can be linear, branched, aliphatic, cycloaliphatic or aromatic and which can optionally contain further heteroatoms, and
n=from 0 to 25,
u=from 0 to 25,
w=from 1 to 40
and R¹, R² and/or w can, within the silane, be identical or different,
and (D) optionally further rubbers, fillers and rubber auxiliaries.

2. Rubber mixtures according to claim 1, characterized in that the diene rubber (A) is composed of repeat units based on 1,3-butadiene and styrene and optionally has been functionalized with hydroxy groups and/or with carboxy groups.

3. Rubber mixtures according to claim 2, characterized in that the diene rubber (A) is composed of from 40 to 100% by weight of 1,3-butadiene and from 0 to 60% by weight of styrene, and the proportion of bonded functional groups and/or of their salts is from 0.02 to 5% by weight, based on 100% by weight of diene rubber.

4. Rubber mixtures according to one or more of claims 1 to 3, characterized in that the proportion of the styrene/butadiene rubber gel, based on 100 parts by weight of the total amount of rubber, is from 1 to 100 parts by weight.

5. Rubber mixtures according to one or more of claims 1 to 3, characterized in that the proportion of the styrene/butadiene rubber gel, based on 100 parts by weight of the total amount of rubber, is from 5 to 75 parts by weight.

6. Rubber mixtures according to one or more of claims 1 to 5, characterized in that the styrene/butadiene rubber gel is an XSBR-styrene/butadiene copolymer or graft polymer, containing hydroxyethyl methacrylate, hydroxypropyl methacrylate, hydroxybutyl methacrylate, ethylene glycol dimethacrylate, trimethylolpropane trimethacrylate and/or pentaerythritol tetramethacrylate.

7. Rubber mixtures according to one or more of claims 1 to 6, characterized in that, as silane, a compound of the formula II 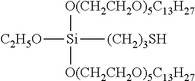
is used.

8. Process for the production of the rubber mixtures according to one or more of claims 1 to 7, characterized in that the mixture constituents are mixed at temperatures of from 20 to 220° C. in a mixing apparatus.

9. Use of the rubber mixtures according to one or more of claims 1 to 7 for the production of rubber vulcanizates.

10. Use of the rubber mixtures according to one or more of claims 1 to 7 for the production of tyre treads.
